(19) United States
(12) Patent Application Publication
(10) Pub. No.: US 2010/0299629 A1
(43) Pub. Date: Nov. 25, 2010

(54) PROCESS FOR DISPLAYING A PORTION OF A HISTORY GRAPH SELECTED BY A USER

(75) Inventors: Fridolin FAIST, Oberwolfach (DE); Thomas OEHLER, Gengenbach (DE); Andreas SCHMIDT, Schonach (DE)

Correspondence Address: THE NATH LAW GROUP, 112 South West Street, Alexandria, VA, 22314, US

(73) Assignee: VEGA GRIESHABER KG, Wolfach (DE)

(21) Appl. No.: 12/779,996

(22) Filed: May 14, 2010

Related U.S. Application Data
(60) Provisional application No. 61/213,239, filed on May 20, 2009.

(30) Foreign Application Priority Data
May 20, 2009 (EP) 09 006 808.1

(51) Int. Cl. G06F 3/048

(52) U.S. Cl. 715/801

(57) ABSTRACT

The invention relates to a process for displaying a portion of a history graph selected by a user with an interactive element belonging to a computer-supported user interface with a graphic display, where the graphic data pertaining to the history graph is stored in a data storage. In accordance with the invention, a portion of the history graph which is expanded or augmented relative to the portion selected by the user is established from the graphic data, such that the portion selected by the user is surrounded by and simultaneously lies at the center of the associated expanded portion of the history graph. The graphic data of the expanded portion of the history graph is provided to the user interface, and the portion selected by the user is displayed on the graphic user interface in the form of a display section of the associated expanded portion of the history graph.

The invention relates to a process for displaying a portion of a history graph selected by the user with an interactive element belonging to a computer-supported interface with a graphic display, in accordance with the preamble of patent claim 1. The invention also relates to a system for implementing the process.

To monitor industrial processes in the context of process automation, process data—e.g., measuring data such as temperature, pressure, fill level, etc.—are transmitted to a control station or measuring station, or to an operational center, or to a central server for storage, so that long-term records of such process data can be retrieved from that point and evaluated.

It is also frequently the case that measuring stations belonging to the government have measuring data that is made accessible to the public.

The internet provides an ideal platform to make such data available to users for the purpose of monitoring and evaluation. Here the measuring data are stored on a server, and the desired data are accessed via internet applications in the context of a client-server structure. The internet applications—in which the data, e.g., time-specific data, are visualized as line graphs by means of a graphic user interface—are intended to provide aids for comfortable navigation within the line graphs.

In the programming of conventional client-server applications, it is known to employ so-called user controls which provide the user with functionalities for displaying graphs, enlarging or reducing graphic sections, and moving a display section on the complete graph. Usually this moving process is performed with so-called scrollbars, but in newer applications any desired point on a display section can be seized with a so-called moving tool that has a pointing device (e.g., a mouse), and can then be moved with the pointing device.

In web applications, so-called charting components are also known, which serve to display line graphs in the web browser and also provide elements for reducing or enlarging display sections, as well as provide capabilities for moving a display section of this kind on the complete graph.

In route planning, highly convenient tools for moving display sections in map materials are offered by the web browsers, e.g., Google.

In the general field of web applications, the required display section is shown on the web browser in a so-called charting component, which provides moving functions, to be sure, but does not offer the ease of operation that was the case, e.g., for route planning, as mentioned above.

Typically the above-described charting components offer only the area choice via additional control such as list boxes (selection of day, week, year, etc) or controls for the direct input of the start and end date. Other variants provide scrollbars for moving a display section.

Other controls are also known as variations, which, in the moving mode, display a wide frame, with the outer dimensions of the graph, rather the graph itself. This frame can be seized inside the web browser display through use of the pointing device (e.g., a mouse), moved, and again released at any desired point in the charting component. The area within the frame is transparent, and no upcoming graph is visible when the display section is moved.

The goal of the invention is to specify a process for the display of a portion of a case history graph selected by the user, whose data is stored in a data storage—and in particular to specify a process in which the indicated disadvantages are overcome. The selection is performed with an interactive element belonging to a computer-supported user interface with a graphic display. It is a further goal of the invention to specify a system for implementing the process according to the invention.

The first goal is achieved by a process with the features of patent claim 1.

As specified by the invention, an associated portion of the history graph that is expanded relative to the portion selected by the user is determined from the graphic data stored in the data storage and in such a way that the portion selected by the user is surrounded by this associated expanded portion and simultaneously lies at the latter's center, while the graphic data of the expanded portion of the history graph is provided to the user interface and the portion selected by the user is reproduced on the graphic user interface as an display section of the associated expanded portion of the history graph.

Available to the user interface are not only the portion of the history graph selected by the user, but also the graphic data of an associated expanded portion of the history graph, which has a larger area than that of the selected portion, such that the selected portion is located precisely in the center of the graph of the associated expanded portion. When the moving function of the graphic user interface is employed, the required image area is available, and rises the display section is moved.

Moving occurs ‘fluidly’ in all directions, and the user has the impression that the entire history graph is present on the user interface. This is made particularly clear to the user in that the history graph moves through the display section during the moving operation, with the result that those parts of the graph which are moved across the borders of the image section disappear, while parts of the graph that were previously not visible are brought up in dynamic fashion. Thus, at every point in time during the actual moving process a complete history graph is visible within the display section.

According to an advantageous elaboration of the invention, the display section can be moved inside of the associated expanded portion of the history graph by means of scrolling with an interactive element, while for the moved display section—i.e., when the moving operation is complete—a new associated expanded portion of the history graph is established from the graphic data stored in the data storage and is provided to the user interface.

Thus for the moved display section a new associated expanded portion of the history graph is established and made available to the graphic user interface after each completed process of moving the display section within the associated expanded portion. Thus, for the moved display section a fluid movement within the new associated expanded portion of the history graph is again permitted, and in the same manner.

In an elaboration of the invention the moving function is performed on the display section with an interactive element, preferably a pointing device (e.g., a mouse), such that a directional path of movement is marked to determine the direction and length by which the display section is moved. This provides an intuitive and comfortable method of navigating within the display section.

It is particularly advantageous if at least one line graph is produced from the data stored in the data storage, in a Cartesian coordinate system with at least two axes, preferably an x-axis and a y-axis, and if the line graph can be scrolled with the interactive element along each axis of the Cartesian coordinate system in the context of the expanded portion of the history graph.

In a further elaboration of the invention, scrolling is performed with the pointer of the pointing device (e.g., a mouse), used as an interactive element, in that a path is marked by the movement of the pointer and by actuation of an additional element belonging to the pointing device. Here the number of image pixels covered by the scrolling path is advantageously determined, and from this, and from the graphic data of the current display section, the graphic data of the moved display section and of the associated expanded portion of the history graph are established.

In a graphic display using a Cartesian coordinate system, it is particularly preferred if the new start and end values of the axes of the Cartesian coordinate system are calculated from the original start and end values of the axes by using the traversed image pixels in order to determine the graphic data of the moved display section and of the associated expanded portion of the history graph.

Since the graphic data preferably involve measured data, the x-axis of the Cartesian coordinate system represents a time axis. For the purpose of scrolling the line graph, the path of movement is then marked on the time axis, the number of traversed image pixels is converted into units of time, and by using these units of time the start and end values of the time axis are determined for the graphic data of the moved display section and for the associated expanded portion of the history graph.

For the representation of line graph, not only the actual line graph but also the representation of the associated axial division and axial inscription is important to the user. In a further elaboration of the invention, consequently, the depiction of the axes of the Cartesian coordinate system is synchronized with the depiction of the line graph.

To permit the user to select a portion of the depicted history graph, the graphic user interface has a zoom function, which is employed with an interactive element. In selecting a portion of the depicted history graph, furthermore, the user can make a direct selection.

The second problem addressed by the invention is solved by a system for implementing the process according to the invention and has the features of patent claim 4.

This system for implementing the process according to the invention comprises a computer with a user interface; a storage for storing the expanded portion of the history graph that is associated with the portion selected by the user; and a server which communicates over a telecommunication network with the computer as a client.

It is particularly advantageous if an internet browser is installed on the computer to communicate with the web server, by means of which the graphs, in particular, can be displayed. It is also advantageous that no additional installations are necessary on the client computer.

The invention is next described in detail on the basis of an exemplary embodiment with reference to the attached figures. Shown are:

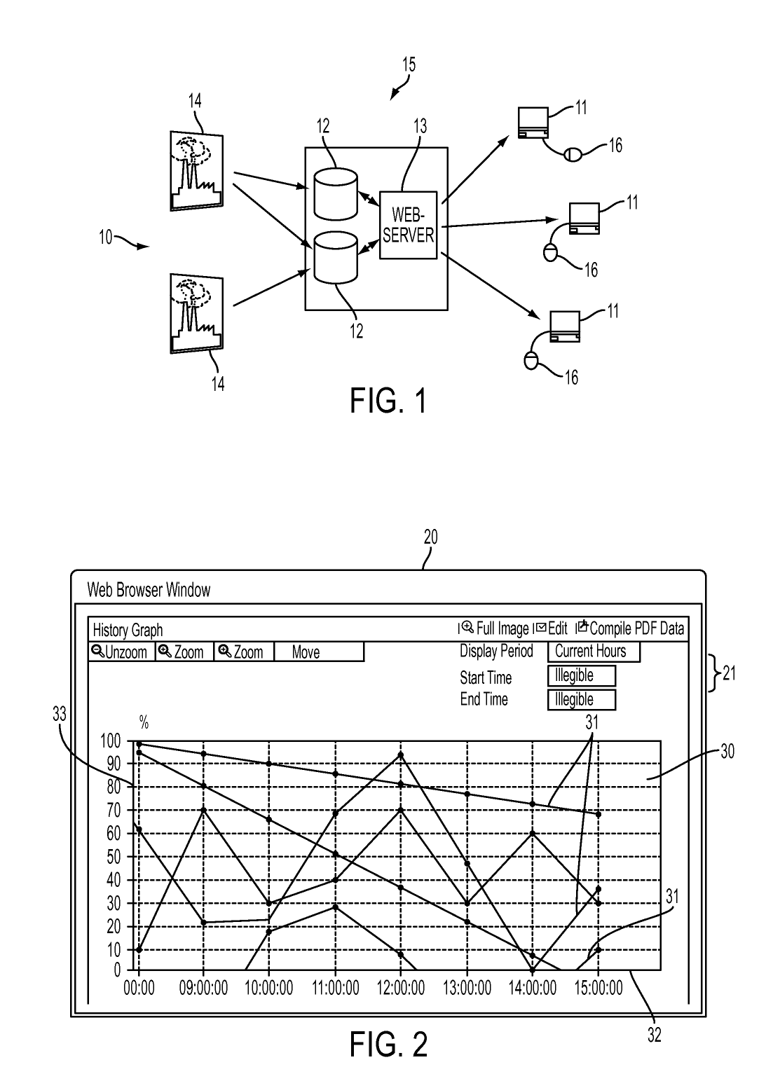

FIG. 1 a schematic depiction of a system for applying the process according to the invention

FIG. 2 a web browser window from a graphic user interface, with a selected portion of a history graph having line graphs

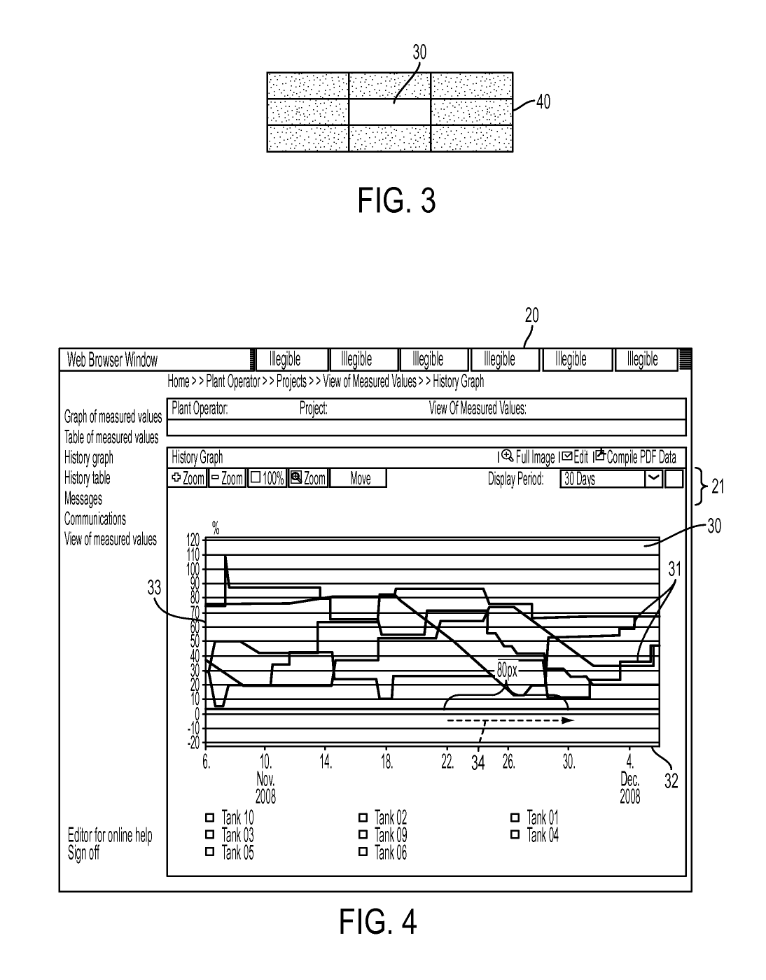

FIG. 3 a schematic depiction of an expanded portion associated with a selected portion of a history graph, in accordance with the invention

FIG. 4 another web browser window from a graphic user interface, showing the selected portion of a history graph, with line graphs

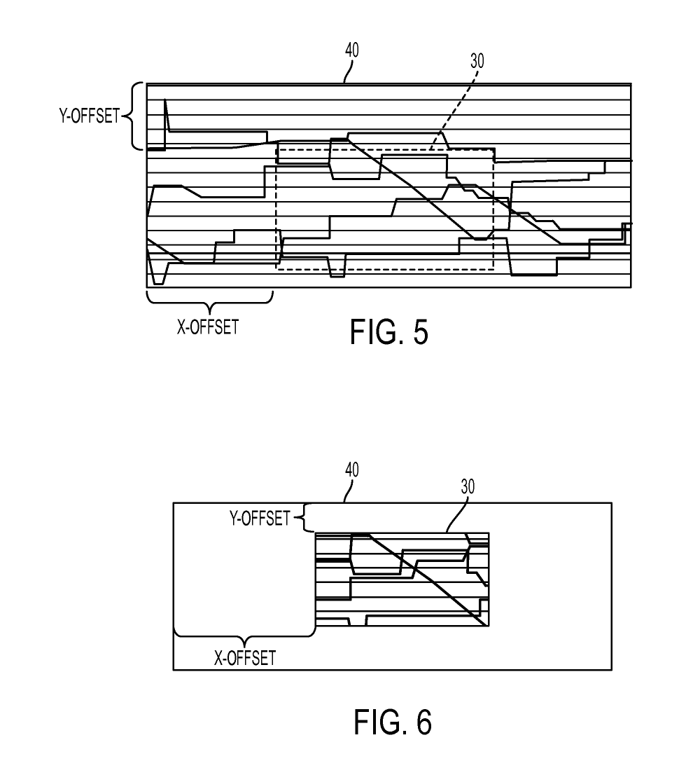

FIG. 5 a depiction of an expanded portion of the history graph with line graphs, in accordance with the invention

FIG. 6 a depiction of the selected portion as a display section of the associated expanded portion of the history graph, with line graphs, in accordance with the invention.

FIG. 1 shows, by way of example, a system 10, in which measured values relating to time are recorded by a measuring station 14 (e.g., in the context of an industrial process occurring in an industrial plant) and are passed on to a control center 15, in which the measured data are centrally archived in a data storage 12. This may involve a plurality of measuring stations, each with a number of measuring channels. By means of a web application it is possible for a user at a user interface 11 representing the client, with a graphic interface, keyboard, pointing device (mouse) 16, and web browser, to access measured data in the form of history graphs from a web server over the internet. The control center 15, together with the user interface 11, represents a client-server entity or structure.

FIG. 2 depicts this kind of web browser window 20, with a line graph 30 consisting of multiple curves 31 in an x-y coordinate system, with a time axis 32 and a scaled y-axis 33.

The different functionalities of the history graph can be selected from a menu bar, such as zoom-in and zoom-out, and moving or scrolling. In addition, a calendar control function or area list can be lodged behind the text field, which the user activates by clicking

If the user requests a portion of the line graph by selecting a portion of the line graph with the zoom tool or with area definitions in a different form (e.g., using the calendar control or the area list), the web browser transmits this request to the web server 13 as an XML, in accordance with FIG. 1. When the zoom tool is selected, the desired area is identified in the web browser by means of JavaScripts, before the transmission is made to the web server 13 as an XLM. Here it must be mentioned that the http protocol is used for communication between the client and the server and that communication from client to server (via http) is initiated by JavaScript. The actual information is transmitted as an XML.

In the web server 13 the portion of the history graph selected by the user is constructed as an image, and not only the requested image area is produced—i.e., the portion of the history graph selected by the user—but also an associated expanded portion of the history graph, which, as an image, has at least eight times the area of the requested image area, and such that the portion selected by the user is located in the exact center of the associated expanded portion of the history graph.

This is schematically depicted in FIG. 3. There the portion selected by the user is indicated by reference numeral 3, which lies in the center of a 3×3 matrix, whose area represents the associated expanded portion 40 produced as image area by the web server 13. The portion selected by the user 30 is surrounded by the associated expanded portion 40 of the history graph.

This expanded portion 40 associated with the selected portion 30 is returned by the web server to the web browser of the user interface 11, and upon delivery to the web browser via JavaScript, the HTML DIV element is communicated to indicate that area of the graph delivered to the browser and corresponding to the portion 30 selected by the user that should be visible in the history graph.

In concrete terms, this means that, in accordance with the exemplary embodiment shown in FIG. 2, a user selects the following portion 30:

Start value: Mar. 30, 2009; 08:00:00 hours
End value: Mar. 30, 2009; 15:00:00 hours

The web server 13, however, issues the associated expanded portion 40 with e.g. the following start and end values:

Start value: Mar. 30, 2009; 01:00:00 hours
End value: Mar. 30, 2009; 22:00:00 hours

This portion 40 is sent back to the web browser, and because of the communicated DIV element only the selected portion is shown in the web browser window (see FIG. 2) as display section 30 of the expanded portion 40. Other details are further explained below.

If a moving operation is performed, e.g., by passing the mouse pointer over the selected portion while simultaneously holding down the mouse button (e.g., the left button), the graph is seized and moves with the mouse pointer, in the context of the portion 30 selected by the user. Because not only the selected portion 30 of the history graph is loaded in the web browser, but a much larger part, specifically an associated expanded portion 40 of the history graph (as described above), the required image area is available to the web browser and comes up when there is a moving operation inside the portion selected by user—i.e., parts of the graph disappear from the display section and other parts of the graph rise into the display section.

The moving operation is typically realized with Dynamic HTML means. Technologies like JavaScript, Document Object Model (DOM), AJAX, and other known means are available for this.

If the moving function is completed by releasing the moved graph—i.e., by releasing the depressed mouse button—for the selected portion that is now present an associated expanded portion, with the current portion in its center, is immediately created and is downloaded into the web browser. This is explained in the following.

FIG. 4 also depicts a web browser window 20 with a user-selected portion 30 of a line history graph, and shows the measured values from a plurality of measuring points as curves 31. The time axis (x axis) 32 shows a period extending from Nov. 6, 2008 to Dec. 6, 2008. The values on the y axis 33 are scaled with values from −20% to 120%.

To move the portion 30 selected in the web browser window 20 (as shown in FIG. 4), a scrolling path 34 is produced by moving the mouse 16 (scrolling) while the mouse button is depressed. This scrolling path begins at time 11-22 [November 22] and ends on 11-30 [November 30], when the left mouse button is released. As explained above, this action causes the graph that is seized by the mouse pointer to move over the scrolling path 34.

The path traversed is read out in pixel units by JavaScript and is transmitted to the web server 13 as an XM; in the indicated time period, the path equals, e.g., 80 px in the x-direction and 0 px in the y-direction.

The scrolling path 34 expressed by the “pixel number” is converted into units of time in the web server 13. Proceeding from a pixel number in the x-direction and y-direction of 733px and 305px for the depicted portion 30, then 60px correspond to a scrolling period of 8 days.

In the next step, the new start and end time for the x-axis is calculated by subtracting the calculated scrolling time from the formerly displayed start and end time:

New start time: November 6−8 days=October 29.
New end time: December 6−8 days=November 28.

This gives the new display time period: October 29 to November 28.

Since there is no scrolling in the y-direction, the y-axis is unchanged.

In addition, the associated expanded portion 40 is established in the web server 13 by attaching other portions to the axes in all directions, as is depicted in the schema according to FIG. 3.

The associated expanded portion 40 has, e.g., the following values for the x- and y-axes:

x-axis: Sep. 30 (start time) to December 28 (end time)
y-axis: 260% (maximum) to 160% (minimum).

With these expanded start and end times, the associated expanded portion 40 is generated as a graph with the components of ChartDirector, as shown in FIG. 5. The horizontal and vertical offsets—designated in FIG. 5 as X-offset and Y-offset—are accordingly determined by a rule-of-three calculation. These offsets represent the distance in pixels between the new calculated start time and the expanded calculated start time.

In another step, the generated image of the expanded portion 40, the calculated offsets, the new calculated start and end times, and the new expanded start and end times of the expanded portion 40 are transmitted to the web browser, and an update is performed with this data for the client, i.e., the user interface. This means that the received image of the expanded portion 40 is positioned within an HTML DIV element by means of the X- and Y-offsets, which are also received—and that there is a representation of the display time period selected by the user with the completed scrolling operation, in that the DIV element crops off all projecting image parts, as per FIG. 6, so that only the selected portion is visible as the display section 30 of the associated expanded portion of the history graph.

The history graph is produced as a line graph without the x- and y-axes, and thus without the associated axial division and axial inscription, although the x-axis remains for horizontal scrolling.

The separate preparation of the x- and y-axes takes places at the same time as the event just described and according to the same schema as the above-described calculation of the new expanded axial values or of the position of the expanded portions of the history graph. There are thus three independent images which have to be synchronized with each other. Thus, at the same time as the step described above, the x- and y-axes are synchronized with the expanded portion of the history graph. In the process the axial representation always dynamically adjusts itself to the immediately visible image area corresponding to the selected portion, even during the scrolling process.

As a result, it is possible to provide the user with a view of the display section of a history graph of any desired size, and for each interaction the user is given the impression that the complete history graph is already loaded in the web browser. Fluid scrolling of the display section is thereby made possible, since loading periods are not required during the scrolling process, but only after the scrolling event is completed, i.e., only after the mouse button is released.

### LIST OF REFERENCE NUMERALS

10 client-server structure with measuring points or measuring stations
11 user interface with graphic display
12 data storage belonging to a web server 3
13 web server
14 measuring points or measuring stations
15 control center
20 web browser window
21 menu bar
30 selected portion of a history graph
31 curves in the portion of a history graph
32 x-axis of the portion of the history graph
33 y-axis of the portion of the history graph
34 scrolling path/path described by moving operation
40 the expanded portion of the history graph associated with selected portion 30

1. A process for displaying a portion of a history graph selected by a user with an interactive element belonging to a computer-supported user interface with a graphic display, where the graphic data of the history graph is stored in a data storage,
wherein
a portion of the history graph which is expanded or augmented relative to the portion selected by the user is established from the graphic data, such that the portion selected by the user is surrounded by and simultaneously lies at the center of the associated expanded portion of the history graph,
the graphic data of the expanded portion of the history graph is provided to the user interface, and
the portion selected by the user is displayed on the graphic user interface as a display section of the associated expanded portion of the history graph.

2. The process according to claim 1,
wherein
the display section can be moved inside of the associated expanded portion of the history graph by means of scrolling with the interactive element, and
an associated expanded portion of the history graph is established for the moved display section from the graphic data stored in the data storage, and this associated expanded portion is provided to the user interface.

3. The process according to claim 2,
wherein
a directional path of movement, or scrolling path, is marked on the reproduced display section by means of the interactive element, and this path establishes the direction and length by which the display section is moved.

4. The process according to claim 1,
wherein
at least one line graph is produced from the data stored in the data storage, for display in a Cartesian coordinate system having at least two axes.

5. The process according to claim 4,
wherein
the interactive element can be used to scroll the line graph, over each axis of the Cartesian coordinate system, in the context of the expanded portion of the history graph.

6. The process according to claim 3,
wherein
scrolling is performed by means of the pointer of a pointing device, which is used as the interactive element, in that a path of movement is marked by movement of the pointer and upon actuation of an additional element belonging to the pointing device.

7. The process according to claim 6,
wherein
the number of image pixels traversed along the scrolling path is recorded, and from them and from the graphic data of the current display section, the graphic data of the moved display section and of the associated expanded portion of the history graph are determined.

8. The process according to claim 7,
wherein
in determining the graphic data of the moved display section, and of the associated expanded portion of the history graph, from the original start and end values of the axes of the Cartesian coordinate system, the new start and end values of the axes are calculated using the traversed image pixels.

9. The process according to claim 4,
wherein
the x-axis of the Cartesian coordinate system is an axis of time.

10. The process according to claim 9,
wherein
to scroll the line graph, the path of movement is marked, the number of traversed image pixels is converted in units of time, and from these units of time the start and end values of the time axis are determined for the graphic data of the moved display section and for the associated expanded portion of the history graph.

11. The process according to claim 4,
wherein
the display of the axes of the Cartesian coordinate system is synchronized with the display of the line graph.

12. The process according to claim 1,
wherein
a zoom function executed with the interactive element is provided to the user when selecting a portion of the history graph.

13. The process according to claim 1,
wherein
the user is provided with a direct choice in selecting a portion of the history graph.

14. A system for implementing the process according to claim 1, comprising
a computer with a user interface and a storage for storing the expanded portion of the history graph associated with the portion selected by the user, and
a server, which communicates over a telecommunication network with the computer as client.

15. The system according to claim 14,
wherein
the server takes the form of a web server.

16. The system according to claim 15,
wherein
an internet browser is installed on the computer for communication with the web server.

17. The system according to claim 16,
wherein
the graphs are displayed by means of the internet browser.
